(19) United States
(12) Patent Application Publication
(10) Pub. No.: US 2004/0141867 A1
(43) Pub. Date: Jul. 22, 2004

(54) Composite material and method for production thereof

(76) Inventors: Klaus Dreyer, Essen (DE); Dieter Kassel, Witten (DE)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/477,981

(22) PCT Filed: May 13, 2002
(86) PCT No.: PCT/DE02/01710

(30) Foreign Application Priority Data
May 16, 2001 (DE) 101 24 051.1
Jun. 27, 2001 (DE) 101 30 590.7

(51) Int. Cl. B32B 9/00

(52) U.S. Cl. 419/8; 428/408; 428/698

(57) ABSTRACT

The invention relates to a composite material, comprising a hard metal or cermet substrate body, coated with at least one diamond layer. According to the invention, the adhesion of the diamond layer on fine-grained hard metal or cermet substrate bodies may be improved, whereby the C content of the hard metal or cermet substrate body lies between 89% and 99%, preferably between 94% and 99% of the maximum possible content at which C porosity occurs, or, for hard metal substrate bodies with Co binder, the magnetic saturation polarisation is 89 to 99%, preferably 94 to 99% of the maximum saturation polarisation 4 π σmax=2Co−2,2 Cr3C2, (Co and Cr3C2 each given in mass % and 4 π σmax in μT.m3.kg−1).

The invention relates to a composite material, comprised of a hard metal substrate body or a cermet substrate body, which is coated with at least one diamond layer.

Such composite materials are used especially as machining tools and as structural parts.

The reference to “hard metal” is to be understood as referring generally to alloys which are comprised of one or more hard materials and one or more binder metals. The hard materials can be especially carbides of a group IVa through VIa of the Periodic System, of which WC is a significant example and can comprise the predominant proportion. Binder metals are iron, cobalt and nickel, preferably cobalt, which can make up a 2 to 25 mass % proportion in the hard metal. Cermets are high titanium carbonitride-containing hard metals which have a hard material phase composed exclusively of carbonitrides of the elements of Groups IVa to VIa of the Periodic System.

It is also known that with WC—Co hard metals, additives such as TaC and/or NbC in small proportions up to 3 mass % can be incorporated for improving the high temperature characteristics and the ductility to break of the composite material. Additives in the form of VC and/or Cr₃C₂ are introduced in fine grained (WC<1 μm) hard metals as so-called grain growth inhibitors in amounts up to 10 mass % with reference to the binder metal content. In current processes for the production of hard metal substrate bodies, pulverulent starting materials (hard substances and binder metals) are milled in the desired composition, granulated, pressed to a so-called green body which is then sintered and optionally subjected to hot isostatic pressing in a subsequent treatment to bring about the desired density. The setting of the C-content is of decisive significance for the hard metal. The sintered structure should have neither an 77 phase nor free carbon (C porosity).

It is also generally known to provide such substrate bodies with a diamond coating by means of a CVD process [chemical vapor deposition process]. However one generally cannot avoid, as has already been indicated in German patent document DE 199 14 585 C1, ablation of the diamond coating which can render the tool unusable. To avoid such ablation, in European patent document EP 0 279 898 B1, European patent document EP 0 752 293 A2, U.S. Pat. No. 5,139,372 and also the German patent document 199 14 585 C1, multilayer carbon coatings or diamond coatings are proposed in which the individual layers differ by various diamond proportions, compressive stresses or moduluses of elasticity. In the case of coarse-grained hard metal, the satisfactory adherence of the diamond layer is a consequence of a clamping effect on the substrate surface. Nevertheless the useful life attainable in this manner of such composite bodies remains unsatisfactory.

It is thus the object of the present invention to provide a composite material and a method of making it in which an improved adhesion of the diamond coating to fine-grained hard metal substrates or cermet substrates is ensured. This object is achieved with the composite material according to claim 1. According to the invention, the C content of the hard metal substrate body or cermet substrate body is established between 89% and 99% and preferably between 94% and 99% of the maximum possible C content at which C porosity still does not arise. With hard metals as a Co binder, the allowable range for the C content is that for which the magnetic saturation polarization in terms of 4 π σ is 89 to 99%, preferably 94 to 99% of 4 π σmax where 4 π σmax=2 Co−2.2 Cr₃C₂ (Co and Cr₃C₂ here being given respectively in mass %, 4 π σmax being given in μ.m³.kg⁻¹.

Cobalt is counted as a so-called ferromagnetic material so that a magnetization of a hard metal gives rise to an increase in the magnetic induction (magnetic flux density) up to a maximum value which is designated as the magnetic saturation. The magnetic saturation is both a characterization of the magnetic physical properties of the ferromagnetic cobalt-rich mixed crystal of the binder phase as well as of the volume of the ferromagnetic material. The carbon content is a controlling influence upon the magnetic saturation polarization of the hard metal alloy. The carbon content is to be compared in a monotungsten carbide with a stoichiometric content of 6.13% carbon. With an atomic ratio of tungsten to carbon below 1, carbon precipitates out in the form of graphite and with a W:C atomic ratio which is substantially in excess of 1, the so-called n phase precipitates out. In the case of an undercarbonization, i.e. a tungsten excess, tungsten solubalizes in cobalt as a result of which from a certain degree of subcarbonization to the formation of a double carbide phase CO₃W₃C, the η phase exists. As a result of this cobalt binding, the ferromagnetic proportion drops and is associated with a reduced magnetic saturation. The Cr₃C₂ addition also reduces the saturation polarization since in the Co binder phase up to 10 mass % Cr₃C₂ can be solubilized.

A requirement for the attainable hardness of the finished sintered hard metal body is also the grain size of the carbide particles, especially the tungsten carbide. To maintain a reduced grain size, doses of VC, Cr₃C₂ and/or (Ta,Nb)C are introduced to the starting mixtures to limit grain growth. VC is the most effective of these growth limiters, and gives rise to an increase in the hardness of the hard metal body. Cr3C₂ doping gives a uniform lattice structure with good elongation (ductility) to break as can be obtained also with TaC and/or NbC doping.

Upon a diamond coating of the mentioned hard metal body as can be carried out in a carbon-containing atmosphere by means of a CVD process, there is a danger that the vanadium contained in the hard metal body and the binder metal Co will diffuse to the surface which is based upon the results obtained according to the invention, can give rise to a poorer adhesion of the diamond coating to the hard metal body. Surprisingly the adhesion of the diamond coating can be significantly improved when the C content of the hard metal is limited to 89% to 99%, preferably 94% to 99% of the maximum C content (Cmax) at which C-porosity arises. With hard metals having a Co binder, this region can be given in terms of 4 π σ whereby 4 r a is limited to 89 to 99%, preferably 94 to 99% of 4 π σmax=2 Co−2.2 Cr₃C₂ being given in mass % and 4 π σmax in AT m³.kg⁻¹.

Preferably the hard metal substrate body has a composition with 2 to 10 mass %, preferably 3 to 7 mass % cobalt as the binder metal and up to 3 mass % TaC and/or NbC as well as, relative to the binder metal content, up to 10 mass % VC and/or Cr₃C₂, balance WC.

To provide the desired carbon content in the hard metal bodies, different process technological features can be used.

Initially the carbon contents can be established at a corresponding level in the powder mixture composition to produce sufficient saturation. Since during the hard metal sintering process the gas atmosphere which is used, the temperature, the pressure and the furnace components which establish the sintering temperature, for example graphite heating rods, also influence the sintered product, the method described in claim 3 is preferably used whereby the pulverulent starting materials are milled, granulated and pressed into a green body and the green body is then sintered and optionally the finished sintered body is subjected to after-treatment before the diamond coating.

To avoid an undesirable subcarbonization of the sintered body, the green body is preferably subjected to a heating up phase at a temperature of 800° C. to 1100° C. in an atmosphere of H₂ containing up to 1 volume % CH₄. A pressure of 1 bar or in an atmosphere of Ar with at least 0.1 volume % CH₄ under a pressure ≧1 bar with a heat treatment in which the deficiency to C saturation established in the starting powder mixture is made up by additional carbonization. This additional carbonization is effected during the heating up phase to the sintering temperature and before the sintering.

As an alternative thereto, according to a further feature of the invention, it is possible to treat the finished sintered body which has too low a carbon content at a temperature between 1000° C. and 1350° C. in a gas atmosphere containing up to 1 volume % CH4 to deposit carbon in the layers of the body close to the surface to a penetration depth of 200 to 500 μm.

This after treatment can also be carried out in a CVD coating apparatus in situ prior to the diamond deposition.

Within the framework of the present invention it is also possible to combine the aforementioned process techniques with one another to ensure optimization of the carbon content.

Preferably from the point of view of the carbon content and optimally establishing it in the finished sintered and optionally also hot isostatically pressed sintered body before coating, still further pretreatment steps can be effected like ray or beam treatment, cleaning, etching, seeding, introduction of foreign elements into the surface or the application of intermediate layers.

Prior to the CVD diamond coating, it is as a rule required to remove the binder by a wet chemical etching (or other suitable methods) from the surface so that there is a paucity of the binder metal also in the boundary layers close to the surface and which has a positive effect on the adhesive strength of the point to the subsequently applied diamond coating. The invention also includes, therefore, the formation of a low binder region or one from which the binder has been removed. All kinds of etching and CVD diamond coating methods can be used. These methods are known as state of the art. As additional support, the substrate can be covered with fine diamond seeds or nuclei in order to increase the nuclei or seed density. A first prehandling step can also be advantageous in which the surface is blasted with a moderate stream of abrasive agents. This step serves to roughen the surface, to remove detrimental products from previous processes and/or to round sharp edges. Before each pretreatment step as a rule, an appropriate cleaning step is required. Less useful but also possible are pretreatment processes which introduce foreign elements into the surface zone or with the aid of which intermediate layers are applied.

In a first embodiment a pulverulent starting mixture (particle size of the starting powder about 0.7 μm) with the composition 93.07% WC, 0.20% VC, 0.53 Cr₃C₂ and 6.20% Co, is milled together, granulated, pressed to a green body and then sintered.

To establish the carbon content in the hard metal body, the sintering process is so carried out that during the vacuum heating phase at 850° C. with a retention time of 2 hours, a gas atmosphere of H₂ with 0.5 volume % CH₄ is used to a pressure of 1000 mbar. The thus obtained hard metal sintered body has a magnetic saturation polarization of 97% of the maximum value.

In a second embodiment, a starting mixture with the components: 91.75% WC, 0.94% TaC, 0.62% NbC, 0.14% VC and 6.55% Co is milled together, granulated, pressed to a green body and then sintered. To establish the carbon content in the hard metal body, the sintering process is so formed that during the vacuum heating up phase after reaching a temperature of 950° C., the temperature is lowered to 850° C. under an argon gas pressure of 900 mbar. There follows a retention time of 2.5 hours at 850° C. under a gas atmosphere of H₂ with 0.5 volume % CH₄ at a pressure of 1000 mbar.

The sinter cycle is brought to its termination subsequently under vacuum. The thus obtained hard metal sintered body has a magnetic saturation polarization of 97.5% of the maximum value. Before coating the aforementioned hard metal bodies, they are cleaned for 30 minutes in acetone by means of ultrasound, a 10 minute etching of the surface in 25 volume % nitric acid at room temperature, 30 minute nucleation in an ultrasound bath in ethanol with 6 g/l diamond powder with an average particle size of 5 μm and a renewed 30 minute cleaning in acetone by means of ultrasound.

For coating the thus pretreated bodies in a hot filament apparatus, a gas atmosphere of 1 volume % CH₄ and 99 volume % H₂ and the following coating parameters are established:

| | |
|---|---|
| Substrate temperature: | 850° C. |
| Filament temperature: | 2000° C. |
| Total pressure: | 2000 Pa |
| Mean distance to the filament | 10 mm |
| Coating duration | 18 hours |
| Total gas flow per 1 of apparatus volume | 25 mln/min |

(mln indicates standard ml - i.e. ml under standard temperature and pressure corresponding to the physical standard state at 0° C. (=273.15 K) and 101325 Pa).

The layer obtained with this coating has a thickness of about 6 μm.

In a further example, finished sintered, ground or unground hard metal bodies with a composition of 91.75% WC, 0.94% TaC, 0.62% NbC, 0.14% VC and 6.55% Co, whose carbon content was 85% of the maximum carbon content and thus below the advantageous range of 89% to 99% and preferably 94% to 99% for adhesion of a diamond layer, were cleaned for 30 minutes in ultrasound, etched for 10 minutes in a 25% nitric acid at room temperature, nucleated for 30 minutes under ultrasound in ethanol with 6 g/l diamond powder with a mean particle size of 5 μm, subsequently cleaned for 30 minutes under ultrasound and introduced into a hot filament coating apparatus. To carbonize the layers close to the surface, the hard metal bodies were treated for an hour for 1100° C. in a gas atmosphere of H₂ with 0.5 volume % CH₄ at a total pressure of 1000 mbar. For applying the coating, the substrate temperature was dropped to 850° C. and the process carried out exactly as previously described. The coating obtained in this example had a thickener of about 6 μm.

For completion refer to the multistage diamond coating method described in WO 00/60137 which also can be used.

The improvement of the coating adhesion with increasing C content or increasing saturation polarization can be seen from the following example:

The respective tested samples with a composition of 6.55 mass % cobalt, 0.14 mass % VC and balance tungsten carbide have after the corresponding previously described treatment a magnetic saturation polarization or 4 πσ values which lie in the following

| | % of maximum possible C-content, | 4 πσ |
|---|---|---|
| Range No. | at which still no C-porosity arises | UT · m³ · kg⁻¹ |
| 1 | 80-88% | 10.5-10.8 |
| 2 | 89-93% | 11.7-11.8 |
| 3 | 94-99% | 12.8-13.0 |

Three sample bodies for each of the ranges with approximately the same thicknesses of diamond coating, corresponding to the above-mentioned ranges, were subjected to a blast wear test over a maximum test period of 120 seconds, and the diamond layer was removed from the test body with range 1 after 7 s, 2 s and 14 s, the diamond layer for the test body in range 2 was already removed after 6 s, 30 s and 55 s and the diamond layer for the test body of range 3 remained intact even after 120 s. This indicates that especially with magnetic saturation polarization between 94 and 99% a durable adhesion of the diamond coating to the hard metal substrate body is attainable.

1. A composite material comprised of a hard metal or cermet substrate body which is coated with at least one diamond layer, characterized in that the C content of the hard metal or cermet substrate body is between 89% and 99%, preferably between 94% and 99% of its maximum possible content at which sill no C porosity arises, or in the case of a hard metal substrate body with a Co binder, magnetic saturation polarization is 89 to 99%, preferably 94 to 99% of the maximum saturation polarization 4 π σmax=2 Co−2.2 Cr₃C₂ (where Co and Cr₃C₂ are each given in mass % and 4 π σmax is given in μT.m³.kg⁻¹).

2. A composite material corresponding to claim 1, characterized in that the hard metal substrate body contains 2 to 10 mass %, preferably 3 to 7 mass % of cobalt as a binder metal and up to 3 mass % TaC and/or NbC, based upon the binder phase, up to 10 mass % VC and/or Cr₃C₂, the balance tungsten carbide with a fine graininess ≦1 μm.

3. A method of producing a composite body according to claim 1 or 2 in which the pulverulent starting materials are milled, granulated, pressed to a green body and the green body is then sintered, the finished sintered body is optionally after-treated and finally coated, characterized in that the green body is brought to the desired carbon content by heat treatment in the heating-up phase at a temperature of 800° C. to 1100° C., preferably at 900° C., in an atmosphere of H₂ with up to 1 volume % CH₄ under a pressure of 1 bar or in an Ar atmosphere with ≧0.1 volume % CH4under a pressure of 1 bar or in an Ar atmosphere with ≧0.1 volume % CH4 at a pressure of ≧1 bar.

4. A method of making a composite material according to claim 1 or 2 in which the pulverulent starting material is milled, granulated, pressed into a green body, the green body is subsequently sintered, the completed sintered body is optionally after-treated and finally coated, characterized in that the carbon unsaturated finished sintered hard metal sintered body is after-treated at a temperature between 1250° C. and 1350° C. in a gas atmosphere containing up to 1 volume % CH4 for carbonizing the layers close to the surface to a penetration depth of 200 to 500 μm.

5. A method according to one of the claims 3 or 4, characterized in that the finished sintered and optionally after-treated sintered body, prior to coating is subjected to additional pretreating steps like blasting, cleaning, etching, nucleation, the incorporation of foreign elements into the surface or the application of intermediate layers.
